(19) United States
(12) Patent Application Publication
(10) Pub. No.: US 2007/0251261 A1
(43) Pub. Date: Nov. 1, 2007

(54) Hot water supplying refrigerator and control method thereof

(75) Inventors: Seok-jun Son, Gwangju-city (KR); Seong-ki Jeong, Yongin-si (KR); Jin-oh Seok, Gwangju-city (KR); Seon-ho Kim, Gwangju-city (KR); Eun-hee Jung, Gwangju-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/715,442

(22) Filed: Mar. 8, 2007

(30) Foreign Application Priority Data
Apr. 27, 2006 (KR) 10-2006-0038250
Jun. 28, 2006 (KR) 10-2006-0058789

(51) Int. Cl. B67D 5/63; B67D 1/00; B67D 5/00; B67D 5/14; B67D 5/62

(52) U.S. Cl. 62/390

(57) ABSTRACT

A hot water supplying refrigerator which includes a main body having a storage compartment, a door opening and closing the storage compartment, and a dispenser provided to the door. The refrigerator includes a hot water tank storing water supplied from an outside, a heater heating water stored in the hot water tank, a hot water pipe connecting the hot water tank and the dispenser, a circulating part circulating water remained in the hot water pipe to the hot water tank, and a control part controlling the heater. Thus, the present invention provides a hot water supplying refrigerator and a control method thereof supplying hot water with a constant temperature, and preventing water remained in a hot water pipe from being wasted.

### CROSS-REFERENCE TO RELATED APPLICATIONS

This application claims priority from Korean Patent Application Nos. 10-2006-0058789, filed on Jun. 28, 2006, and 10-2006-0038250, filed on Apr. 27, 2006, in the Korean Intellectual Property Office, the disclosures of which are incorporated herein by reference.

### BACKGROUND OF THE INVENTION

1. Field of the Invention

The present invention relates to a hot water supplying refrigerator and a control method thereof More particularly, to a hot water supplying refrigerator and a control method thereof supplying a hot water with a constant temperature.

2. Description of the Related Art

Recently, a conventional refrigerator has been provided with various functional units for enhancing convenience to a user. For example, a home bar and a dispenser are provided to a front of a door of the refrigerator.

Since a user can obtain water or ice without opening the door through the dispenser, the dispenser can prevent cool air inside the refrigerator from leaking out. Also, recently, a refrigerator having a hot water supplying unit which is capable of supplying hot water as well as cold water through the dispenser has been released.

The conventional refrigerator preheats water by a heater, stores the preheated water in a hot water storing tank, and supplies the hot water through a dispenser. To constantly maintain the temperature of water stored in the hot water storing tank, the heater is periodically operated or is controlled depending on a measured temperature of a temperature sensor disposed in the hot water storing tank.

A hot water pipe is connected between the hot water storing tank and the dispenser. When a user obtains hot water, a user becomes supplied with water remaining in the hot water pipe between the hot water storing tank and the dispenser at an initial time.

However, since the remaining water is cooled, the user wastes the water remaining in the hot water pipe, to obtain hot water at a desired temperature.

### SUMMARY OF THE INVENTION

Accordingly, it is an aspect of the present invention to provide a hot water supplying refrigerator and a control method thereof supplying hot water with a constant temperature.

Also, it is an aspect of the present invention to provide a hot water supplying refrigerator and a control method thereof preventing water remaining in a hot water pipe of the refrigerator from being wasted.

Additional aspects and/or advantages of the invention will be set forth in part in the description which follows and, in part, will be apparent from the description, or may be learned by practice of the invention.

The foregoing and/or other aspects of the present invention can be achieved by providing a hot water supplying refrigerator including a main body including a storage compartment, a door to open and close the storage compartment, and a dispenser provided to the door, the refrigerator including a hot water tank to store water supplied from an outside, a heater to heat the water stored in the hot water tank, a hot water pipe to connect the hot water tank with the dispenser, a circulating part to circulate water remaining in the hot water pipe to the hot water tank, and a control part to control the heater.

According to an aspect of the present invention, the circulating part includes a circulating pipe diverging from the hot water pipe to be connected with the hot water tank, and a pump forcedly circulating the water remaining in the hot water pipe and the circulating pipe to the hot water tank.

According to an aspect of the present invention, the pump is disposed to a part of the circulating pipe.

According to an aspect of the present invention, the hot water supplying refrigerator further includes a water supplying pipe to supply water supplied from an outside to the hot water tank, a water supplying valve to regulate water supplied to the hot water tank through the water supplying pipe, a water gauge to measure a level of water stored in the hot water tank, and a first temperature sensor to measure a temperature of water stored in the hot water tank, wherein the control part controls the heater and the water supplying valve based on signals detected by the water gauge and the first temperature sensor.

According to an aspect of the present invention, the control part opens the water supplying valve to supply water to the hot water tank when the water gauge detects no change of the water level of the hot water tank for a predetermined time after the water gauge detects that the water level of the hot water tank is smaller than a reference level.

According to an aspect of the present invention, the hot water supplying refrigerator further includes a regulating valve provided to the hot water pipe and the water supplying pipe adjacent to the hot water tank, to regulate water flowing in and out of the hot water tank.

According to an aspect of the present invention, the circulating part further includes a pump switch selecting operating (on) or stopping (off) of the pump.

According to an aspect of the present invention, the control part operates the pump for a predetermined time when the operating of the pump is selected in the pump switch.

According to an aspect of the present invention, the control part operates the pump to have a predetermined period when the operating of the pump is selected in the pump switch.

According to an aspect of the present invention, the circulating part further includes a second temperature sensor provided to one of the hot water pipe and the circulating pipe, and the control part operates the pump when the operating of the pump is selected in the pump switch, and temperature measured by the second temperature sensor is determined to be smaller than a predetermined pump operating temperature.

According to an aspect of the present invention, after the pump is operated, the control part stops operating the pump when the temperature measured by the second temperature sensor is determined to be larger than a predetermined pump stopping temperature.

According to an aspect of the present invention, the control part operates the heater to interlock with the operating of the pump.

According to an aspect of the present invention, the hot water supplying refrigerator further includes a hot water valve provided to the hot water pipe between the dispenser and a diverging part of the hot water pipe and the circulating pipe to regulate water supplied to the dispenser.

According to an aspect of the present invention, the dispenser includes an input part selecting cold water or hot water.

According to an aspect of the present invention, the hot water supplying refrigerator further includes a valve switch selectively opening and closing the hot water valve, wherein the control part opens the hot water valve when the hot water is selected in the input part, and the valve switch is operated.

According to an aspect of the present invention, the dispenser further includes an outlet connected with the hot water pipe to eject the hot water, and a water lever selectively opening and closing the outlet, wherein the valve switch interlocks with the water lever.

According to an aspect of the present invention, the hot water supplying refrigerator further includes a vapor ventilating part provided to an upper part of the hot water tank to adjust vapor pressure in the hot water tank.

According to an aspect of the present invention, the vapor ventilating part includes a vent housing including a vapor inflow hole to receive vapor in the hot water tank, a vapor outflow hole to eject vapor received through the vapor inflow hole to an outside, and a vapor channel to connect the vapor inflow hole with the vapor outflow hole, and a vent lid movably provided between the vapor inflow hole and the vapor outflow hole to approach or withdraw from the vapor inflow hole depending on the vapor pressure in the hot water tank, to open and close the vapor inflow hole.

According to an aspect of the present invention, the hot water supplying refrigerator further includes a heater switch selecting one of a normal mode in which the heater selectively heats and stops heating water stored in the hot water tank and a suspended mode in which the normal mode is withdrawn to suspend operating of the heater, wherein the control part controls the heater to maintain water stored in the hot water tank with a predetermined temperature when the normal mode is selected in the heater switch.

According to an aspect of the present invention, the control part closes the water supplying valve and stops operating of the heater when the suspended mode is selected in the heater switch.

According to an aspect of the present invention, the hot water supplying refrigerator further includes a hinge part including a hollow hinge shaft provided to one of the main body and the door, and a hinge shaft coupling part provided to the other of the main body and the door to be rotatably coupled with the hollow hinge shaft, wherein the hot water tank is disposed to an upper part of the main body, and the hot water pipe and the circulating pipe are disposed inside the hollow hinge shaft.

The foregoing and/or other aspects of the present invention can also be achieved by providing a hot water supplying refrigerator including a main body including a storage compartment, a door opening and closing the storage compartment, and a dispenser provided to the door, the refrigerator including a hot water tank provided to an upper part of the main body, to store water supplied from an outside, a heater to heat water stored in the hot water tank, a hot water pipe to connect the hot water tank with the dispenser, a circulating part to circulate water remaining in the hot water pipe to the hot water tank, and a selecting part to select one of a normal mode in which the heater selectively heats and stops heating water stored in the hot water tank and a suspended mode in which the normal mode is withdrawn to suspend operating of the heater.

According to an aspect of the present invention, the circulating part includes a circulating pipe diverging from the hot water pipe to be connected with the hot water tank, and a pump forcedly circulating the water remaining in the hot water pipe and the circulating pipe to the hot water tank.

According to an aspect of the present invention, the circulating part further includes a pump switch selectively operating the pump.

According to an aspect of the present invention, the hot water supplying refrigerator further includes a vapor ventilating part provided to an upper part of the hot water tank to adjust the vapor pressure in the hot water tank.

According to an aspect of the present invention, the hot water supplying refrigerator further includes a water supplying pipe to supply water supplied from an outside to the hot water tank, a water supplying valve to open and close the water supplying pipe, and a control part to operate the heater, to thereby maintain water stored in the hot water tank at a predetermined temperature when the normal mode is selected in the heater switch, and closing the water supplying valve and stopping operating of the heater when the suspended mode is selected in the heater switch.

According to an aspect of the present invention, the hot water supplying refrigerator further includes a hinge part including a hollow hinge shaft provided to one of the main body and the door, and a hinge shaft coupling part provided to the other of the main body and the door to be rotatably coupled with the hollow hinge shaft, wherein the hot water tank is disposed to an upper part of the main body, and the hot water pipe and the circulating pipe are disposed inside the hollow hinge shaft.

The foregoing and/or other aspects of the present invention can also be achieved by providing a hot water supplying refrigerator including a main body including a storage compartment, a door to open and close the storage compartment, and a dispenser provided to the door, the refrigerator including a hot water tank storing water supplied from an outside, a hot water pipe to connect the hot water tank and the dispenser, a circulating pipe diverging from the hot water pipe to be connected with the hot water tank, a hot water valve provided to the hot water pipe between the dispenser and a diverging part of the hot water pipe and the circulating pipe, and regulating water supplied to the dispenser, a temperature sensor provided between the hot water tank and the hot water valve to sense a temperature of the water, and a pump forcedly circulating water remaining in the hot water pipe and the circulating pipe to the hot water tank.

According to an aspect of the present invention, the hot water supplying refrigerator further includes a control part operating the pump in a state that the hot water valve is closed when the temperature measured by the temperature sensor is determined to be smaller than a predetermined pump operating temperature.

The foregoing and/or other aspects of the present invention can also be achieved by providing a hot water supplying refrigerator including a main body including a storage compartment, a door to open and close the storage compartment, and a dispenser provided to the door, the refrigerator including a hot water tank to store water supplied from an outside, a hot water pipe to connect the hot water tank with the dispenser, a circulating pipe diverging from the hot water pipe to be connected with the hot water tank, a pump forcedly circulating water remaining in the hot water pipe and the circulating pipe to the hot water tank, a hot water valve provided to the hot water pipe between the dispenser and a diverging part of the hot water pipe and the circulating pipe, and regulating hot water supplied to the dispenser, a water lever selectively opening and closing the hot water valve, and a control part controlling the pump to interlock with the water lever.

According to an aspect of the present invention, the control part opens the hot water valve after operating the pump for a predetermined time in a state that the hot water valve is closed when the hot water valve is selected to be open by the water lever.

The foregoing and/or other aspects of the present invention can also be achieved by providing a control method of a hot water supplying refrigerator including a main body including a storage compartment, a door to open and close the storage compartment, a dispenser provided to the door, a hot water tank to store water supplied from an outside, a heater to heat water stored in the hot water tank, a hot water pipe to connect the hot water tank and the dispenser, and a circulating part including a circulating pipe diverging from the hot water pipe to be connected with the hot water tank, and a pump forcedly circulating water remaining in the hot water pipe and the circulating pipe to the hot water tank, and operating the pump.

According to an aspect of the present invention, the pump is operated for a predetermined time.

According to an aspect of the present invention, the pump is operated based on the temperature measured by a temperature sensor provided at least one of the hot water pipe and the circulating pipe.

According to an aspect of the present invention, the hot water supplying refrigerator further includes a hot water valve provided to the hot water pipe between the dispenser and a diverging part of the hot water pipe and the circulating pipe to regulate a hot water supplied to the dispenser, and a water lever to open and close the hot water valve, wherein the hot water valve is opened after operating the pump for a predetermined time in when the hot water valve is closed, when the hot water valve is selected to be opened by the water lever.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view schematically illustrating a refrigerator according to an embodiment of the present invention;

FIG. 2 is a perspective view schematically illustrating an upper portion of the refrigerator including a hot water tank and a circulating part of the refrigerator shown in FIG. 1;

FIG. 3A is an exploded perspective view illustrating a configuration of an upper hinge part, a hot water pipe and a circulating pipe of the refrigerator in FIG. 1;

FIG. 3B is an exploded perspective view illustrating a configuration of a lower hinge part and a cold water pipe of the refrigerator in FIG. 1;

FIG. 4 is a partial cut-away perspective view illustrating a vapor ventilating part of the refrigerator in FIG. 1;

FIGS. 5A and 5B are sectional views illustrating operating states of the vapor ventilating part of the refrigerator in FIG. 4;

FIG. 6 schematically illustrates a configuration of the refrigerator in FIG. 1;

FIG. 7 is a control block diagram of the refrigerator in FIG. 1;

FIGS. 8A to 8D are control flowcharts illustrating various embodiments of a pump control method of the refrigerator in FIG. 1; and

FIG. 9 is a control flowchart of the refrigerator in FIG. 1 according to an operation of a heater switch.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

Hereinafter, a refrigerator of a side-by-side type will be described as a few exemplary embodiments of the present invention. However, the present invention may be applied to a refrigerator of other types.

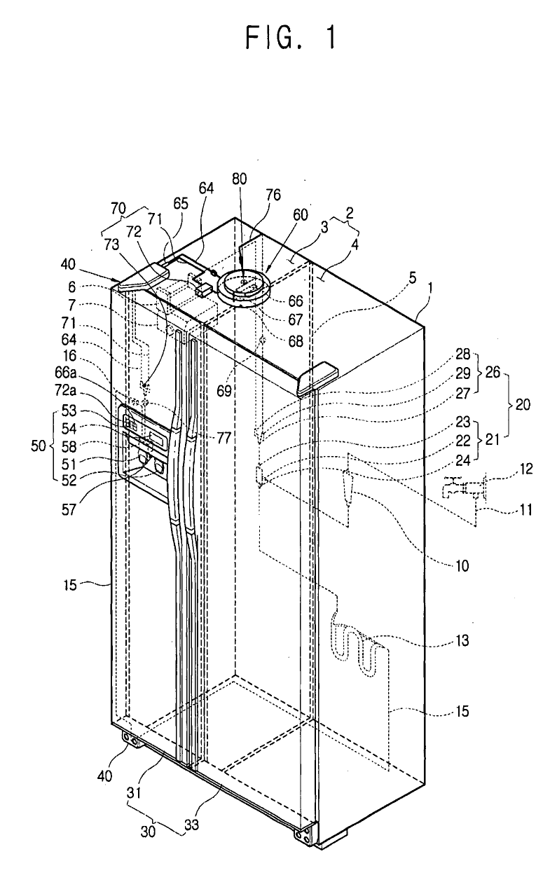

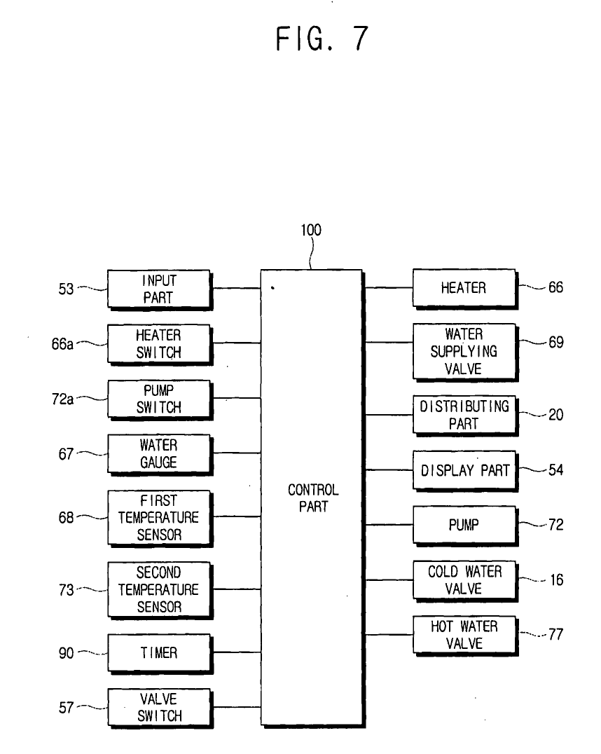

As shown in FIG. 1, a refrigerator according to an embodiment of the present invention comprises a main body 1 forming a storage compartment 2, a door 30 opening and closing the storage compartment 2, a dispenser 50 provided to the door 30, a hot water tank 60 storing water provided from the outside, a heater 66 heating the water stored in the hot water tank 60, a hot water pipe 64 connecting the hot water tank 60 and the dispenser 50, a circulating part 70 circulating water remained in the hot water pipe 64 to the hot water tank 60, and a control part 100 (shown in FIG. 7).

The storage compartment 2 is divided into the opposite sides by a middle wall 5. For example, a freezing compartment 3 is formed to a left side of the middle wall 5, and a refrigerating compartment 4 is formed to a right side thereof. The door 30 is provided to an opening of the storage compartment 2 to open and close the storage compartment 2, and a door guard (not shown) is disposed to an inner side of the door 30 to accommodate bottles, etc.

An ice maker 6 is provided to an upper part of the freezing compartment 3, and an ice storing part 7 is provided under the ice maker 6 to store ice made by the ice maker 6. A shelf (not shown), a drawer (not shown), etc. are provided under the ice storing part 7 to separately store food.

The refrigerating compartment 4 comprises a water purifying part 10 purifying water received from the outside, a cold water tank 13 storing the water purified by the water purifying part 10, and a shelf (not shown) and a drawer (not shown) separately storing food or the like.

The water purifying part 10 purifies water supplied from the outside. The water purifying part 10 comprises a water purifying filter filtering impurities out of water supplied through an external connecting part 11. According to an embodiment of the present invention, the water purifying part 10 is detachably provided so that it can be periodically replaced. The water purifying part 10 is provided to the refrigerating compartment 4, but not limited thereto. Alternatively, the water purifying part 10 may be provided to other parts of the main body 1.

A first end of the external connecting part 11 is connected to an external water source 12, and a second end thereof is connected to the water purifying part 10.

The refrigerator according to an embodiment of the invention comprises a distributing part 20 distributing water supplied through the external connecting part 11 and purified by the water purifying part 10 to be supplied to the ice maker 6, the cold water tank 13 and the hot water tank 60.

The cold water tank 13 is disposed in the refrigerating compartment 4 to store water supplied from the outside at a low temperature. The cold water tank 13 and the dispenser 50 are connected by a cold water pipe 15, and a cold water valve 16 is provided to a part of the cold water pipe 15 to selectively open and close the cold water pipe 15. According to an embodiment of the present invention, the cold water valve 16 comprises a solenoid valve. The cold water valve 16 is opened and closed by a valve switch 57.

The distributing part 20 comprises a first distributing part 21 and a second distributing part 26. The first distributing part 21 comprises three through holes. The first distributing part 21 further comprises an inflow hole 22 through which water is supplied from the water purifying part 10, a first outflow hole 23 connected with the ice maker 6 and the hot water tank 60, and a second outflow hole 24 connected with a pipe connected to the cold water tank 13. Here, water is supplied into the second distributing part 26 through the first outflow hole 23. The first distributing part 21 comprises a solenoid valve controlled by the control part 100 to selectively open and close the first outflow hole 23 and the second outflow hole 24. The first distributing part 21 comprises a connector having a Y-shape.

The second distributing part 26 also comprises three through holes. The second distributing part 26 further comprises an inflow hole 2-7 receiving water passing through the first outflow hole 23 of the first distributing part 21, a first outflow hole 28 connected with a pipe connected to the ice maker 6, and a second outflow hole 29 connected with a water supplying pipe 76 connected to the hot water tank 60. According to an embodiment of the present invention, the second distributing part 26 comprises a solenoid valve controlled by the control part 100 to selectively open and close the first outflow hole 28 and the second outflow hole 29. The second distributing part-26 may comprise a connector having a Y-shape.

The door 30 opens and closes front openings of the freezing compartment 3 and the refrigerating compartment 4. The door 30 comprises a freezing compartment door 31 opening and closing the front opening of the freezing compartment 3, and a refrigerating compartment door 33 opening and closing the front opening of the refrigerating compartment 4. The dispenser 50 is provided to the freezing compartment door 31 to receive ice made by the ice maker 6 and a cold water stored in the cold water tank 13 or a hot water stored in the hot water tank 60.

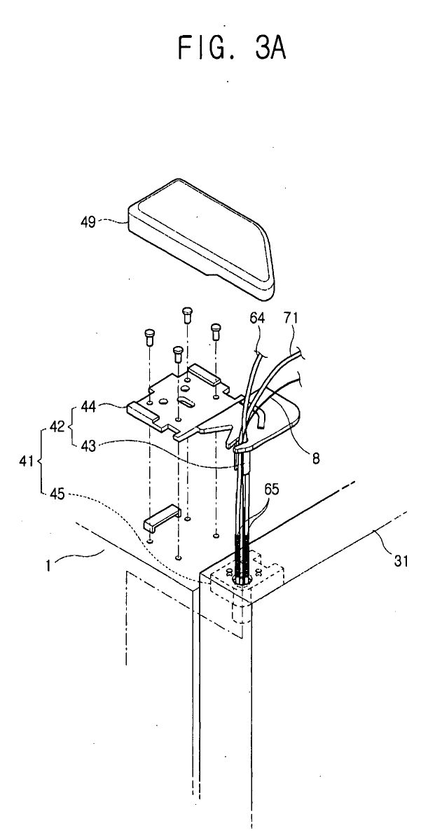

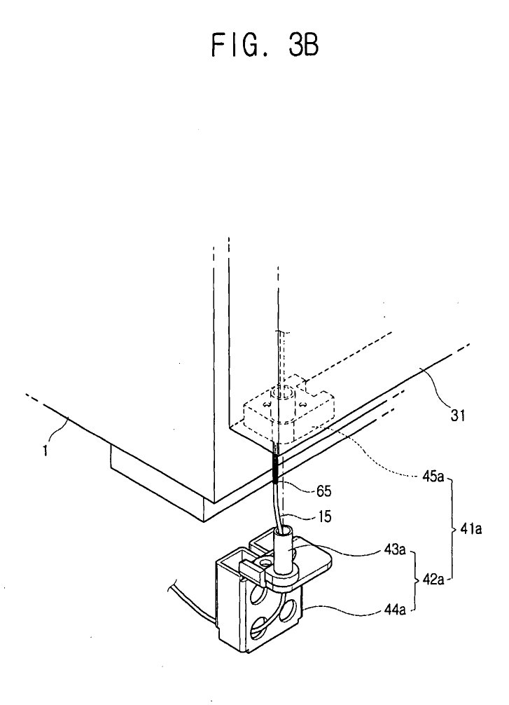

As shown in FIGS. 3A and 3B, the refrigerator according to the embodiment of the invention comprises a hinge part 40 rotatably coupling the door 30 to the main body 1. The hinge part 40 comprises an upper hinge part 41 disposed to upper parts of the door 30 and the main body 1, and a lower hinge part 41a disposed to lower parts of the door 30 and the main body 1.

The upper hinge part 41 comprises a hinge plate 42 provided to the main body 1, a hinge shaft coupling part 45 provided to the door 30, and a hinge cover 49.

The hinge plate 42 comprises a hollow hinge shaft 43 formed through to accommodate the hot water pipe 64 and a circulating pipe 71, and a hinge shaft supporting part 44 coupled to the main body 1. Here, the hot water pipe 64 and the circulating pipe 71 are disposed inside the hollow hinge shaft 43 of the upper hinge part 41. Also, a power line 8, for example, is disposed inside the hollow hinge shaft 43 of the upper hinge part 41 to supply power to the dispenser 50.

The lower hinge part 41a comprises a hinge plate 42a provided to the main body 1, and a hinge shaft coupling part 45a provided to the door 30.

The hinge plate 42a comprises a hollow hinge shaft 43a formed through to accommodate the cold water pipe 15, and a hinge shaft supporting part 44a coupled with the main body 1. Here, the cold water pipe 15 is disposed inside the hollow hinge shaft 43a of the lower hinge part 41a.

Referring to FIG. 1, the dispenser 50 comprises an outlet 58 through which a cold water or a hot water is discharged, a water lever 51 selectively opening and closing the outlet 58, an ice outlet (not shown) through which ice stored in the ice storing part 7 is discharged, an ice lever 52 selectively opening and closing the ice outlet, and an input part 53 for selecting the kind of water, the amount of water to be discharged, etc. According to an embodiment of the present invention, the dispenser 50 comprises a display part 54 displaying information selected by the input part 53, an operating state information of the refrigerator, etc.

The outlet 58 is connected with the cold water pipe 15 and the hot water pipe 64. The outlet 58 selectively receives the cold water or the hot water from the cold water pipe 15 or the hot water pipe 64, and discharges it. The outlet 58 is opened and closed by the water lever 51. Here, the cold water valve 15 and a hot water valve 77 are disposed adjacently to the outlet 58. Also, the outlet 58 comprises other known configurations to selectively discharge the cold water and the hot water.

The water lever 51 selectively opens and closes the outlet 58. For example, the water lever 51 is a lever type. However, the water lever 51 is not limited hereto and may vary as necessary. When a force is applied to the water lever 51, the outlet 58 is opened, and when the force is withdrawn therefrom, the outlet 58 is closed. Alternatively, according to an embodiment of the present invention, the water lever 51 comprises a button or a touch screen type provided to the input part 53, etc.

Referring to FIG. 1, one water lever 51 is provided to be connected with the hot water tank 60 and the cold water tank 13. Alternatively, according to an embodiment of the present invention, a cold water lever and a hot water lever are separately provided.

Various known configurations may be applied to the outlet 58 and the water lever 51, and a configuration including a safety button (not shown) may be applied thereto for enhancing safety when the hot water is discharged.

The input part 53 is provided for a user to select ice or water, hot water or cold water, the amount thereof. The input part 53 comprises various configurations. For example, referring to FIG. 1, the input part 53 may comprise a mechanical button, a reed switch, a touch screen type, etc. The input part 53 may be integrally formed with a heater switch 66a and a pump switch 72a.

The display part 54 displays information inputted by the input part 53, the temperatures of the cold water and the hot water, an operating state of the refrigerator, etc. According to an embodiment of the present invention, when the input part 53 is provided as a touch screen type, the display part 54 comprises a function of the input part 53.

The hot water tank 60 is provided between the water purifying part 10 and the dispenser 50. The hot water tank 60 is provided to an upper part of the main body 1. The hot water tank 60 comprises an inflow hole 61 through which water purified by the water purifying part 10 flows therein through the water supplying pipe 76, a storing part 62 storing water supplied through the inflow hole 61, and an outflow hole 63 through which water stored in the storing part 62 flows out through the hot water pipe 64.

The refrigerator according to the embodiment of the present invention comprises the water supplying pipe 76 supplying water purified by the water purifying part 10 to the hot water tank 60, and a water supplying valve 69 regulating water flowing through the inflow hole 61 of the hot water tank 60. According to an embodiment of the present invention, the water supplying valve 69 comprises a solenoid valve. By controlling the water supplying valve 69, supply of water purified by the water purifying part 10 to the hot water tank 60 can be regulated. Here, in the case that the second distributing part 26 is provided as a solenoid valve, the second distributing part 26 performs a function of the water supplying valve 69. That is, by opening and closing the second outflow hole 29 of the second distributing part 26, water supply to the hot water tank 60 can be regulated.

The hot water pipe 64 connects the outflow hole 63 of the hot water tank 60 and the dispenser 50. Referring to FIG. 3A, the hot water pipe 64 is disposed inside the hollow hinge shaft 43 of the hinge part 40. Here, the hot water pipe 64 penetrating the hollow hinge shaft 43 is buried into a foaming space of the door 30. Accordingly, although the hot water tank 60 is disposed to an upper part of the main body 1, the freezing compartment door 31 can rotate without being interfered. Here, the hot water pipe 64 is formed of a flexible material with thermal resistance. Also, the hot water pipe 64 adjacent to the hollow hinge shaft 43 comprises such a length as to allow the door 30 to rotate without being interfered.

A protecting member 65 is provided to an outer surface of the hot water pipe 64 accommodated inside the hollow hinge shaft 43 so that the hot water pipe 64 is distanced from the power line 8. The protecting member 65 comprises a spring or an elastic member surrounding a bent part of the hot water pipe 64 to protect the bent part thereof.

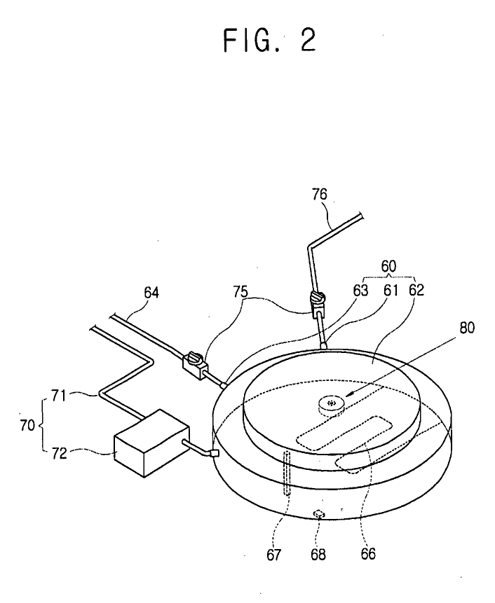

As shown in FIG. 2, the refrigerator urther comprises a regulating valve 75 respectively provided to the hot water pipe 64 and the water supplying pipe 76 adjacent to the hot water tank 60 to regulating water inflow and outflow to the hot water tank 60. The regulating valve 75 comprises a manual valve, which a user manually operates to prevent water stored in the hot water tank 60 from flowing to the hot water pipe 64 and the water supplying pipe 76 when the refrigerator is moved.

The hot water tank 70 is provided with a heater 66 heating water stored in a storing part, a water gauge 67 measuring the amount of water stored in the storing part, and a first temperature sensor 68 measuring the temperature of water stored therein.

The heater 66 is provided to the hot water tank 60 to heat water stored in the hot water tank 60. For example, the heater 66 may be disposed in a part of the hot water tank 60, buried to the hot water tank 60, or attached to an outer surface of the hot water tank 60.

The water gauge 67 measures the level of water stored in the hot water tank 60, and transmits measured information to the control part 100.

The first temperature sensor 68 measures the temperature of water stored in the hot water tank 60, and transmits measured information to the control part 100.

The refrigerator according to the embodiment of the present invention further comprises a heater switch 66a (i.e., a selecting part) controlling power of the heater 66. The heater switch 66a selects one of a normal mode in which the heater 60 selectively heats or stops heating water stored in the hot water tank 60, and a suspended mode in which the normal mode is withdrawn so that the heater 66 stops heating the water. Referring to FIG. 1, the heater switch 66a is provided integrally with the input part 53 according to an embodiment of the present invention, or provided to the dispenser 50 as a separate switch.

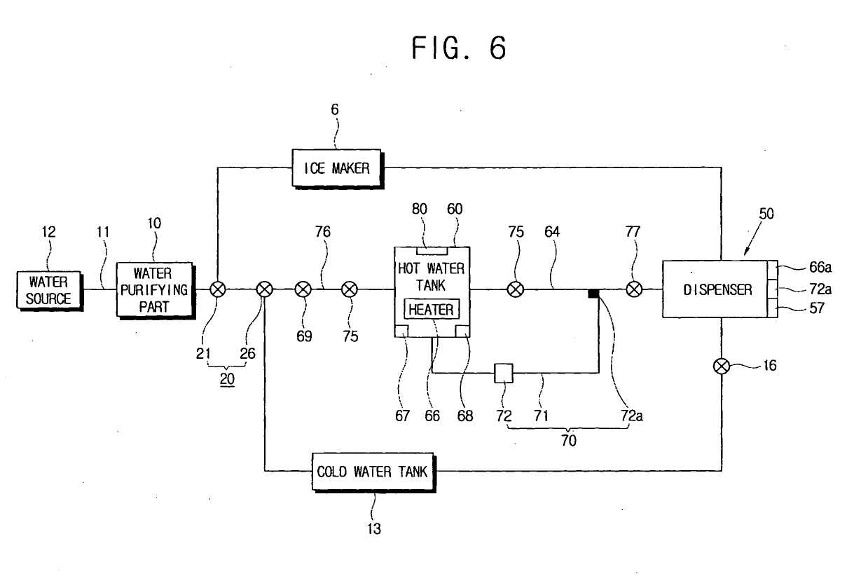

Referring to FIGS. 1, 2 and 6, the circulating part 70 comprises the circulating pipe 71 diverging from the hot water pipe 64 to be connected with the hot water tank 60, a pump 72 forcedly circulating water remained in the hot water pipe 64 and the circulating pipe 71 to the hot water tank 60, and the pump switch 72a regulating the pump 72.

The circulating pipe 71 diverges from the hot water pipe 64 to be connected with the hot water tank 60. That is, the hot water tank 60, the hot water pipe 64 and the circulating pipe 71 are communicatably provided one another. The circulating pipe 71 diverges from a part of the hot water pipe 64 adjacent to the dispenser 50. The circulating pipe 71 is disposed inside the hollow hinge shaft 43 of the upper hinge part 41 like the hot water pipe 64. Here, the circulating pipe 71 penetrating an inner part of the hollow hinge shaft 43 is buried in a foaming space of the freezing compartment door 31. Accordingly, although the hot water tank 60 is disposed to an upper part of the main body 1, the freezing compartment door 31 can rotate without being interfered.

According to an embodiment of the present invention, a protecting member 65 may be provided to an outer surface of the circulating pipe 71 accommodated in an inner part of the hollow hinge shaft 43 to distance the circulating pipe 71 from the power line 8 and the hot water pipe 64. The protecting member 65 comprises a spring or an elastic member surrounding a bent part of the circulating pipe 71 to protect the bent part thereof. Here, according to an embodiment of the present invention, the circulating pipe 71 is formed of a flexible material with thermal resistance. Also, the circulating pipe 71 adjacent to the hollow hinge shaft 43 comprises such a length as to allow the door 30 to rotate without being interfered.

The hot water valve 77 is provided to a part of the hot water pipe 64 between the dispenser 50 and a diverging area between the hot water pipe 64 and the circulating pipe 71 to regulate hot water supplied to the dispenser 50. The hot water valve 77 is opened and closed by the valve switch 57 interlocked with the water lever 51.

A pump 72 is provided to a part of the circulating pipe 71. The pump 72 forcedly circulates water stagnating in the hot water pipe 64 and the circulating pipe 71 between the hot water tank 60 and the hot water valve 77. The pump 72 is placed in an upper part of the main body 1. Here, according to an embodiment of the present invention, the pump 72 circulates water to sequentially pass the hot water tank 60, the hot water pipe 64 and the circulating pipe 71, or oppositely thereto.

The pump switch 72a separately controls power of the pump 72. Referring to FIG. 1, according to an embodiment of the present invention, the pump switch 72a is provided integrally with the input part 53, or alternatively, provided to the dispenser 50 as a separate switch.

The refrigerator according to the embodiment of the present invention further comprises a second temperature sensor 73 provided to the hot water pipe 64 or the circulating pipe 71 between the hot water tank 60 and the hot water valve 77. The second temperature sensor 73 measures the temperature of water remained in the hot water pipe 64 or the circulating pipe 71 between the hot water tank 60 and the hot water valve 77, and transmits it to the control part 100.

The refrigerator according to an embodiment of the present invention comprises a timer 90 measuring time for controlling the heater 66 and the pump 72.

The refrigerator according to the embodiment of the present invention further comprises the valve switch 57 selectively opening and closing the cold water valve 16 and the hot water valve 77. The valve switch 57 is provided in a rear of the water lever 51 to interlock with the water lever 51. The valve switch 57 comprises a mechanical switch such as a push switch, a reed switch, etc. and a sensor such as proximity sensor, etc.

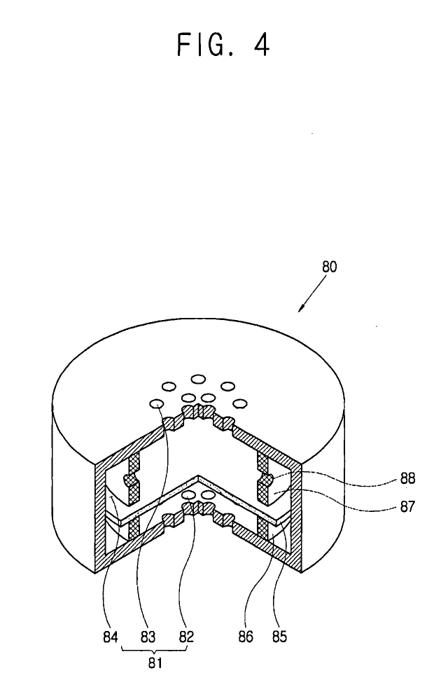

As shown in FIG. 4, the refrigerator according to an embodiment of the present invention further comprises a vapor ventilating part 80 provided to an upper part of the hot water tank 60 to control a vapor pressure in the hot water tank 60.

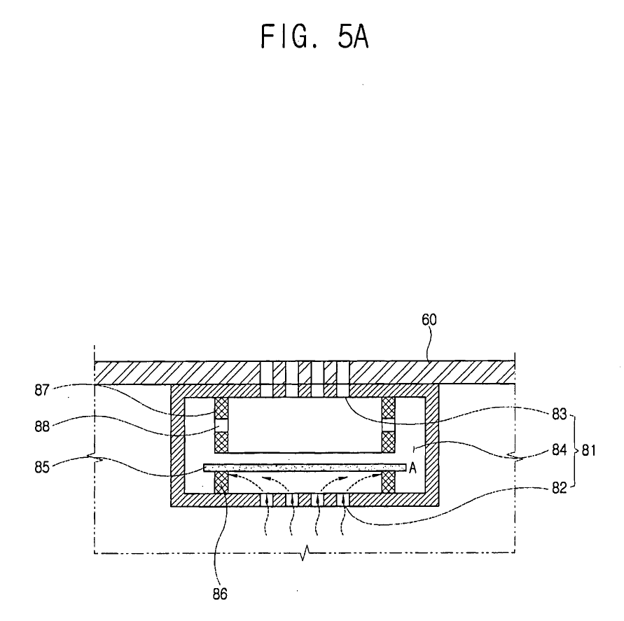

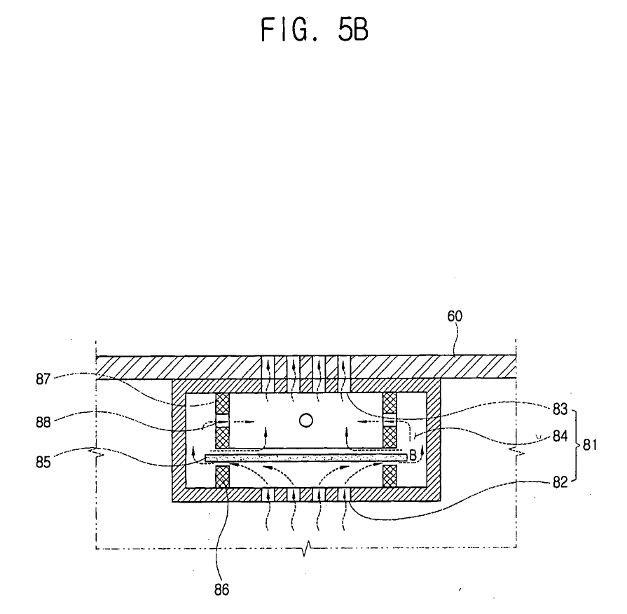

The vapor ventilating part 80 comprises a vent housing 81 guiding vapor in the hot water tank 60 to the outside, and a vent lid 85. According to an embodiment of the present invention, the vapor ventilating part 80 is integrally provided with the hot water tank 60, or detachably provided thereto (see FIGS. 5A and 5B).

The vent housing 81 is provided to an upper part of the hot water tank 60 to have a container shape. The vent housing 81 comprises a vapor inflow hole 82 through which vapor inside the hot water tank 60 flows therein, a vapor outflow hole 83 through which vapor is ejected to the outside, and a vapor channel 84 connecting the vapor inflow hole 82 and the vapor outflow hole 83. A shape of the vent housing 81 may vary as necessary. For example, the vent housing 81 comprises a cylindrical container shape, or a polygonal container shape such as a rectangular container shape, a pentagonal container shape, etc. The vent housing 81 is disposed to an upper surface of the hot water tank 60 to face downward, or an upper surface of the hot water tank 60 to face upward.

The vapor inflow hole 82 is provided through a lower surface of the vent housing 81, and the vapor outflow hole 83 is provided through an upper surface of the vent housing 81. The vent inflow hole 82 and the vent outflow hole 83 face each other. Alternatively, in the case that the vent housing 81 is disposed to an upper surface of the hot water tank 60 to face upward, the vapor outflow hole 83 may be provided to a side surface of the vent housing 81. The vent inflow hole 82 and the vent outflow hole 83 is formed as one through hole, or a plurality of mesh-type through holes.

The vent lid 85 is disposed to the vapor channel 84 between the vapor inflow hole 82 and the vapor outflow hole 83. The vent lid 85 moves between an opening position B in which the vent lid 85 opens the vent inflow hole 82 depending on the vapor pressure of the hot water tank 60, and a closing position A in which the vent lid 85 closes the vent inflow hole 82. The vent lid 85 comprises a plate shape, and is formed of rubber, for example. The vent lid 85 is moved to the opening position B by the vapor pressure of the hot water tank 60 to open the vapor inflow hole 82 when the vapor pressure thereof becomes bigger than a predetermined pressure. Accordingly, vapor in the hot water tank 60 is ejected to outside through the vapor outflow hole 83. The vent lid 85 moves to the closing position A to close the vapor inflow hole 82, when the vapor pressure of the hot water tank 60 becomes small after vapor in the hot water tank 60 is ejected. Accordingly, a foreign substance can be prevented from penetrating into the hot water tank 60.

The vent lid 85 is larger than the vent inflow hole 82. Accordingly, the vent lid 83 completely closes the vapor inflow hole 82 at the closing position A. The vent lid 85 is of a weight so as to move to the opening position B when the vapor pressure of the hot water tank 60 is larger than the predetermined pressure.

The vent housing 81 comprises a lower supporting part 86 protruding upward from a lower surface of the vent housing 81 to support a lower surface of the vent lid 85, and an upper supporting part 87 protruding downward from an upper surface of the vent housing 81 to support an upper surface of the vent lid 85.

The lower supporting part 86 upward protrudes from a circumference of the vapor inflow hole 82 to distance the vent lid 85 from a lower surface of the vent housing 81. Accordingly, the lower supporting part 86 can prevent the vent lid 85 from not moving to the opening position B due to a surface tension because the vent lid 85 is forcedly contacted to the circumference of the vapor inflow hole 82 formed to the lower surface of the vent housing 81 though the vapor pressure of the hot water tank 60 becomes bigger than the predetermined pressure. Here, a through hole (not shown) is further provided to a lower surface of the vent housing 81 so that water condensed out of vapor in the vent housing 81 flows into the hot water tank 60.

The upper supporting part 87 downward protrudes from a circumference of the vent outflow hole 83. The upper supporting part 87 prevents the vent lid 85 from being attached to an upper surface of the vent housing 81 due to moisture.

At least one vapor ventilating hole 88 is formed to a surface of the upper supporting part 87. The vapor ventilating hole 88 guides vapor penetrated through the vapor inflow hole 82 to the vapor outflow hole 83 though the vent lid 85 is forcedly contacted to the lower supporting part 86. Also, the vapor ventilating hole 88 communicates the inside and the outside of hot water tank 60 to allow the vent lid 85 to move to the closing position A though the vent lid 85 is forcedly contacted to the lower supporting part 86.

The control part 100 of the refrigerator according to an embodiment of the present invention controls the respective parts as described below.

At first, a control method for the heater 66 of the refrigerator according to the embodiment of the present invention will be described.

When the normal mode is selected in the heater switch 66a, the control part 100 controls the water supplying valve 69 and the heater 66 so that water stored in the hot water tank 60 maintains a predetermined water level and a predetermined temperature depending on signals transmitted from the first temperature sensor 68 and the water gauge 67.

When the suspended mode is selected in the heater switch 66a, the control part 100 closes the water supplying valve 69, and controls the heater 66 to stop heating. Accordingly, although a user discharges water stored in the hot water tank 60, and accordingly, the water level of the hot water tank 60 becomes smaller than a predetermined level, the water supplying valve 69 is not opened. Accordingly, a user can empty the hot water tank 60 to maintain cleanliness by selecting the suspended mode. Also, an unnecessary driving of the heater 80 can be reduced, thereby reducing power consumption.

The control part 100 opens the water supplying valve 69 to supply water to the hot water tank 60 when the water gauge 67 detects no change of the water level of the hot water tank 60 for a predetermined period after the water level of the hot water tank 60 is measured to be smaller than a predetermined reference level. That is, the control part 100 does not open the water supplying valve 69 although the water level of the hot water tank 60 is measured to be smaller than the predetermined level, while a user is supplied with the hot water of a predetermined amount. Accordingly, the water supplying valve 69 is controlled not to be opened when a user replaces a water container while obtaining the hot water, etc. Accordingly, a user can be supplied with the hot water though a user intends to obtain the hot water with delay such as replacement of a water container.

Hereinafter, a control method for the pump 72 of the refrigerator according to an embodiment of the present invention will be described.

When operating of the pump 72 is selected in the pump switch 72a, the control part 100 operates the pump 72 for a predetermined operating time. Here, the operating time of the pump 72 is determined based on an experiment result. The operating time of the pump 72 is determined to be an average time needed for water remaining in the hot water pipe 64 and the circulating pipe 71 to completely circulate after the pump 72 is initially operated. Accordingly, a user can always obtain the hot water having a constant temperature. Here, noises due to operating of the pump 72 can be prevented by not operating the pump 72 as necessary.

When operating of the pump 72 is selected in the pump switch 72a, the control part 100 operates the pump 72 to have a predetermined operating period. Here, the operating period is determined based on an experiment result, and may be variously determined depending on a set temperature, an outer environment, etc. Here, according to this embodiment of the present invention, the operating period of the pump 72 is determined to be an average time for which the temperature of water remaining in the hot water pipe 64 or the circulating pipe 71 becomes smaller than a predetermined temperature after a user obtains the hot water. Here, a user can always obtain the hot water with a constant temperature as necessary.

When operating of the pump 72 is selected in the pump switch 72a and opening of the outlet 58 is selected in the water lever 51 of the dispenser 50, the control part 100 operates the pump 72 for a predetermined time in the state that the hot water valve 77 is closed. That is, when a user selects operating of the pump 72 to the pump switch 72a and presses the water lever 51, the control part 100 operates the pump 72 for the predetermined time while closing the hot water valve 77 though the valve switch 57 is operated by interlocking with the water lever 51. The control part 100 opens the hot water valve 77 after a predetermined time passes.

The refrigerator according to an embodiment of the present invention does not comprise the pump switch 72a, as necessary. In this case, when the hot water is inputted to the input part 53 and opening of the outlet 58 is selected in the water lever 51 of the dispenser 50, the control part 100 operates the pump 72 to interlock with the water lever 51.

The control part 100 enables operating of the pump 72 to be selected in the pump switch 72a only when the normal mode is selected in the heater switch 66a. The control part 100 operates the heater 66 to interlock with the pump 72 while the pump 72 is operated.

Hereinafter, a control method for the valve switch 57 of the refrigerator according to an embodiment of the present invention will be described.

In the state that the hot water is selected in the input part 53, when the valve switch 57 is operated, the control part 100 opens the hot water valve 77. That is, when a user presses the water lever 51 so that the valve switch 57 is operated after the hot water is inputted in the input part 53, the control part 100 opens the hot water valve 77 to eject the hot water. Also, if a user presses the water lever 51 so that the valve switch 57 is operated after the cold water is inputted in the input part 53, the control part 100 opens the cold water valve 16 to eject the cold water.

Hereinafter, cold and hot water supplying processes of the refrigerator according to the embodiment of the present invention will be described by referring to FIGS. 1, 5 and 6.

At first, a cold water supplying process is described. In the cold water supplying process, water supplied through the external connecting part 11 is purified in the water purifying part 10. The water purified in the water purifying part 10 is supplied to the inflow hole 22 of the first distributing part 21. Water passing through the second outflow hole 24 of the first distributing part 21 moves to the cold water tank 13 disposed in the storage compartment 2. Here, if a user selects the cold water, and presses the water lever 51, the valve switch 57 is operated to open the cold water valve 16, and water stored at a low temperature in the cold water tank 13 is supplied to the dispenser 50 through the cold water pipe 15. Here, the cold water pipe 15 is disposed inside the hollow hinge shaft 43a of the lower hinge part 41a. A pump (not shown) may be provided to a part of the cold water pipe 15.

Then, a hot water supplying process is described. In the hot water supplying process, water supplied through the external connecting part 11 is purified in the water purifying part 10. The water purified in the water purifying part 10 is supplied to the inflow hole 22 of the first distributing part 21. Water passing through the first outflow hole 23 of the first distributing part 21 is supplied to the inflow hole 27 of the second distributing part 26, and water passing through the second outflow hole 29 of the second distributing part 26 is supplied to the water supplying pipe 76. When the normal mode is selected in the heater switch 66a, the control part 100 opens the water supplying valve 69 so that water is supplied to the hot water tank 60 through the water supplying pipe 76. If the water gauge 69 detects a predetermined water level, the heater 66 heats water stored in the hot water tank 60 to have a predetermined temperature based on a signal of the first temperature sensor 68. Then, when a user selects the hot water in the input part 53 and presses the water lever 51, the valve switch 57 is operated to open the hot water valve 77 so that the hot water stored in the hot water tank 60 is ejected. When a user selects operating of the pump 72 in the pump switch 72a, the control part 100 operates the pump 72 based on the above control method. Accordingly, a user can be always supplied with the hot water having a constant temperature as necessary.

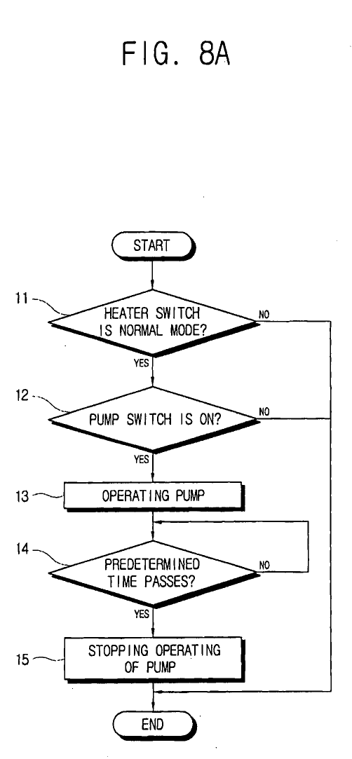

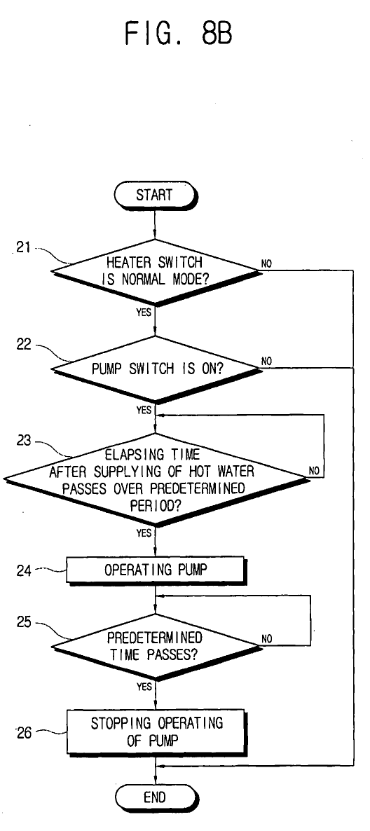

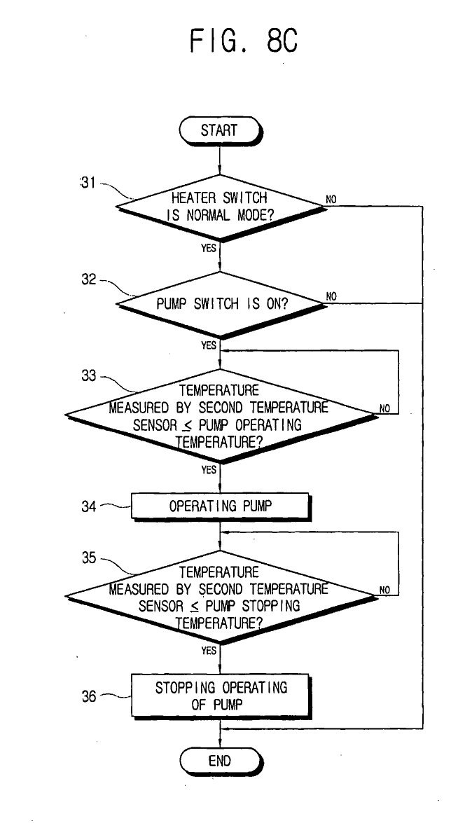

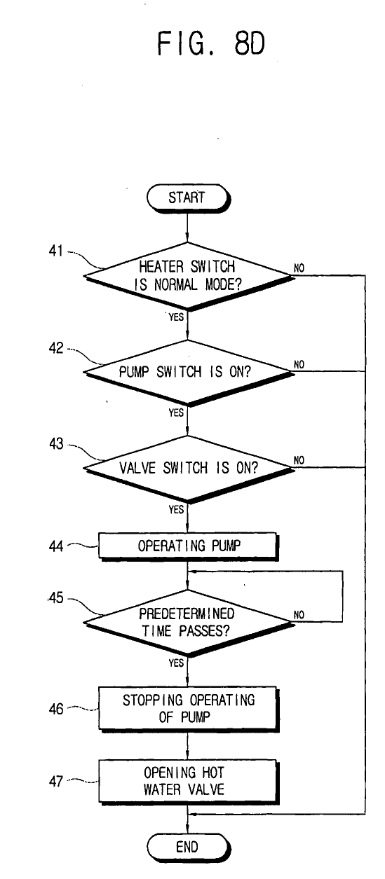

Hereinafter, control methods of the pump 72 of the refrigerator according to various embodiments of the present invention will be described by referring to FIGS. 7, and 8A to 8D.

At first, a control method of the pump 72 of the refrigerator according to a first embodiment of the present invention will described by referring to FIGS. 7 and 8A.

In operation 11, the heater switch 66a is determined whether to be in the normal mode. Here, when the heater switch 66a is determined to be the normal mode in operation 11, the process moves to operation 12, where the pump switch 72a is determined whether to be an on state. Alternatively, when the heater switch 66a is determined to be the suspended mode in operation 11, the controlling of the pump 72 is ended.

In operation 12, if the pump switch 72a is determined to be the on state, the process moves to operation 13, where the pump 72 is operated in the state that the hot water valve 77 is closed. If the pump switch 72a is determined to be an off state in operation 12, the controlling of the pump 72 is ended. Here, the on state of the pump switch 72a refers to a state in which the pump 72 is selected to operate, and the off state of the pump switch 72a refers to a state in which the pump 72 is selected to stop.

After the pump 72 is operated in operation 13, the process moves to operation 14, where it is determined whether a predetermined time has elapsed. If it is determined that the predetermined time has elapsed in operation 14, the process moves to operation 15, where the pump 72 is controlled to stop. If it is determined that the predetermined time has not elapsed in operation 14, operation 14 is repeated.

Hereinafter, a control method of the pump 72 of the refrigerator according to a second embodiment of the present invention will be described by referring to FIGS. 7 and 8B.

In operation 21, the heater switch 66a is determined whether to be the normal mode. Here, if the heater switch 66a is determined to be the normal mode, the process moves to operation 22, where the pump switch 72a is determined whether to be an on state. If the heater switch 66a is determined to be the suspended mode in operation 22, the controlling of the pump 72 is ended.

However, if the pump switch 72a is determined to be the on state in operation 22, the process moves to operation 23, where the timer 90 measures an elapsing time elapsing after a user is supplied with the hot water to determine whether a predetermined period for operating the pump 72 passes. If the pump switch 72a is determined to be an off state in operation 22, the controlling of the pump 72 is ended. Here, the on state of the pump switch 72a refers to a state in which the pump 72 is selected to operate, and the off state of the pump switch 72a refers to a state in which the pump 72 is selected to stop.

If it is determined that a predetermined period has elapsed in operation 23, the process moves to operation 24, where the pump 72 is operated in the state that the hot water valve 77 is closed. If it is determined that a predetermined period has not elapsed in operation 23, operation 23 is repeated.

After the pump 72 is operated in operation 24, the process moves to operation 25, where an operating time of the pump 72 is measured to determine whether a predetermined time passes. Here, if the operating time of the pump 72 is determined to pass over the predetermined time in operation 25, the process moves to operation 26, where the operating of the pump 72 is stopped.

If the operating time of the pump 72 is determined not to pass over the predetermined time in operation 25, operation 25 is repeated.

Hereinafter, a control method of the pump 72 of the refrigerator according to a third embodiment of the present invention will be described by referring to FIGS. 7 and 8C.

In operation 31, the heater switch 66a is determined whether to be the normal mode. Here, if the heater switch 66a is determined to be the normal mode in operation 31, the process moves to operation 32, where the pump switch 72a is determined whether to be an on state. If the heater switch 66a is determined to be the suspended mode in operation 31, the controlling of the pump 72 is ended.

If the pump switch 72a is determined to be the on state in operation 32, the process moves to operation 33, where it is determined whether a temperature measured by the second temperature sensor 73 is smaller than a predetermined pump operating temperature. If the pump switch 72a is determined to be an off state, controlling of the pump 72 is ended. Here, the on state of the pump switch 72a refers to a state in which the pump 72 is selected to operate, and the off state of the pump switch 72a refers to a state in which the pump 72 is selected to stop.

If the temperature measured by the second temperature sensor 73 is determined to be smaller than the predetermined pump operating temperature in operation 33, the process moves to operation 34, where the pump 72 is operated in the state that the hot water valve 77 is closed. If the temperature measured by the second temperature sensor 73 is determined to be bigger than the predetermined pump operating temperature in operation 33, operation 33 is repeated.

After the pump 72 is operated in operation 34, the process moves to operation 35, where it is determined whether a temperature measured by the second temperature sensor 73 is larger than a predetermined pump stopping temperature.

When it is determined that the temperature measured by the second temperature sensor 73 is larger than the predetermined pump stopping temperature in operation 35, the process moves to operation 36, where the operating of the pump 72 is stopped. However, if the temperature measured by the second temperature sensor 73 is determined to be smaller than the predetermined pump stopping temperature in operation 35, operation 35 is repeated.

Hereinafter, a control method of the pump 72 of the refrigerator according to a fourth embodiment of the present invention will be described by referring to FIGS. 7 and 8D.

In operation 41, the heater switch 66a is determined whether to be the normal mode. Here, if the heater switch 66a is determined to be the normal mode in operation 41, the process moves to operation 42, where the pump switch 72a is determined whether to be an on state. If the heater switch 66a is determined to be the suspended mode in operation 41, the controlling of the pump 72 is ended.

If the pump switch 72a is determined to be the on state in operation 42, the process moves to operation 43, where the valve switch 57 is determined whether to be an on stage. Here, since the valve switch 57 interlocks with the water lever 51, when a user presses the water lever 51, the valve switch 57 becomes the on state. If the pump switch 72a is determined to be an off state, controlling of the pump 72 is ended. Here, the on state of the pump switch 72a refers to a state in which the pump 72 is selected to operate, and the off state of the pump switch 72a refers to a state in which the pump 72 is selected to stop.

If the valve switch is determined to be the on state in operation 43, the process moves to operation 44, where the pump 72 is operated in the state that the hot water valve 77 is closed. If the valve switch is determined to be an off state, controlling of the pump 72 is ended.

After the pump 72 is operated in operation 44, the process moves to operation 45, where an operating time of the pump 72 is measured to determine whether a predetermined time passes. If it is determined that the operating time of the pump 72 has passed over the predetermined time in operation 45, the process moves to operation 46, where the pump 72 is controlled to stop.

If it is determined that the operating time of the pump 72 is has not passed over the predetermined time in operation 45, operation 45 is repeated.

After operating of the pump 72 is stopped in operation 46, the process moves to operation 47, where the hot water valve 77 is opened.

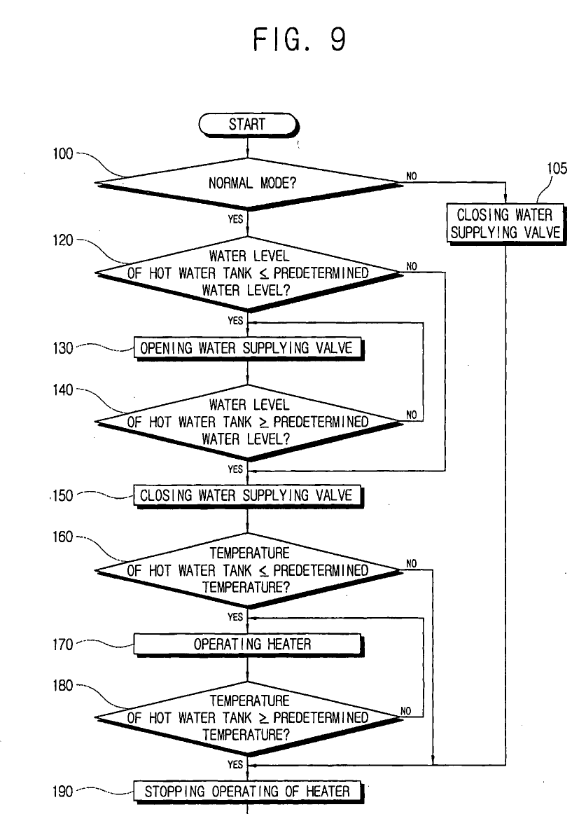

Hereinafter, a control method of the heater switch 66a of the refrigerator according to an embodiment of the present invention will be described by referring to FIGS. 7 and 9.

In operation 100, the heater switch 66a is determined whether to be the normal mode. Here, when it is determined that the heater switch 66a is in the normal mode in operation 100, the process moves to operation 120, where the water gauge 67 measures the water level of the hot water tank 60 to determine whether the water level of the hot water tank 60 is larger than a predetermined water level. If the heater switch 66a is determined to be in the suspended mode in operation 100, the process moves to operation 105 where the water supplying valve 69 is closed, and then to operation 190 where operation of the heater 66 is stopped.

If the water level of the hot water tank 60 measured by the water gauge 67 is determined to be smaller than the predetermined water level in operation 120, the process moves to operation 130, where the water supplying valve 69 is opened. If the water level of the hot water tank 60 measured by the water gauge 67 is determined to be larger than the predetermined water level in operation 120, the process moves to operation 150 where the water supplying valve 69 is closed.

After the water supplying valve 69 is opened in operation 130, the process moves to operation 140 where the water gauge 67 measures the water level of the hot water tank 60 to determine whether the water level of the hot water tank 60 is larger than a predetermined water level. Here, if the water level of the hot water tank 60 measured by the water gauge 67 is determined to be larger than the predetermined water level in operation 140, the process moves to operation 150 where the water supplying valve 69 is closed. If the water level of the hot water tank 60 measured by the water gauge 67 is determined to be smaller than the predetermined water level, the stage S130 is performed.

After the water supplying valve 69 is closed in operation 150, the first temperature sensor 68 measures the temperature of water stored in the hot water tank 60. From operation 150, the process moves to operation 160 where it is determined whether the temperature of water stored in the hot water tank 60 measured by the first temperature sensor 68 is smaller than a predetermined temperature. Here, if the temperature of water stored in the hot water tank 60 measured by the first temperature sensor 68 is determined to be smaller than the predetermined temperature in operation 160, the process moves to operation 170 where the heater 66 is operated. If the temperature of water stored in the hot water tank 60 measured by the first temperature sensor 68 is determined to be larger than the predetermined temperature in operation 160, the process moves to operation 190 where the operation of the heater 66 is stopped.

After the heater 66 is operated in operation 170, the first temperature sensor 68 measures the temperature of water stored in the hot water tank 60. From operation 170, the process moves to operation 180, where it is determined whether the temperature of water stored in the hot water tank 60 measured by the first temperature sensor 68 is determined larger than a predetermined temperature. Here, if the temperature of water stored in the hot water tank 60 measured by the first temperature sensor 68 is determined to be larger than the predetermined temperature in operation 180, the process moves to operation 190 where operation of the heater 66 is stopped. If the temperature of water stored in the hot water tank 60 measured by the first temperature sensor 68 is determined to be smaller than the predetermined temperature in operation 180, the process repeats operation 170.

The refrigerator according to an embodiment of the present invention comprises various configurations for distributing water from the water purifying part 10 to the ice maker 6, the cold water tank 13 and the hot water tank 60. For example, the distributing part 20 may be provided as a four-way valve so that water supplied from the water purifying part 10 to the distributing part 20 is respectively supplied to the ice maker 6, the cold water tank 13 and the hot water tank 60.

The refrigerator according to an embodiment of the present invention, positions the hot water tank 60 to an upper part of the main body 1 so that the hot water tank 60 is distanced from the storage compartment 2 to interpose a foaming material therebetween. Accordingly, heat of the hot water tank 60 can be prevented from being transmitted to the storage compartment 2, thereby reducing power consumption and enhancing refrigerating reliability of the storage compartment 2.

Also, the hot water pipe 64 and the circulating pipe 71 are disposed inside the hollow hinge shaft 43. Accordingly, although the hot water tank 60 is positioned to an upper part of the main body 1, the door 30 rotates without being interfered.

Also, the pump 72 is provided to forcedly circulate water remained in the hot water pipe 64 and the circulating pipe 71 to the hot water tank 60, thereby allowing a user to be always supplied with the hot water having a constant temperature.

As described above, it is an embodiment of the present invention to provide a hot water supplying refrigerator and a control method thereof supplying a hot water with a constant temperature, and preventing water remaining in a hot water pipe from being wasted.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A hot water supplying refrigerator comprising a main body comprising a storage compartment, a door opening and closing the storage compartment, and a dispenser provided to the door, the refrigerator comprising:
a hot water tank to store water supplied from an outside;
a heater to heat water stored in the hot water tank;
a hot water pipe to connect the hot water tank and the dispenser;
a circulating part to circulate water remaining in the hot water pipe to the hot water tank; and
a control part to control the heater.

2. The hot water supplying refrigerator according to claim 1, wherein the circulating part comprises:
a circulating pipe diverging from the hot water pipe to be connected with the hot water tank, and
a pump to forcedly circulate water remaining in the hot water pipe and the circulating pipe to the hot water tank.

3. The hot water supplying refrigerator according to claim 2, wherein the pump is disposed to a part of the circulating pipe.

4. The hot water supplying refrigerator according to claim 2, further comprising:
a water supplying pipe to supply water supplied from an outside to the hot water tank,
a water supplying valve to regulate water supplied to the hot water tank through the water supplying pipe,
a water gauge to measure a level of water stored in the hot water tank, and
a first temperature sensor to measure a temperature of water stored in the hot water tank,
wherein the control part controls the heater and the water supplying valve based on signals detected by the water gauge and the first temperature sensor.

5. The hot water supplying refrigerator according to claim 4, wherein the control part opens the water supplying valve to supply water to the hot water tank, when the water gauge detects no change of the water level of the hot water tank for a predetermined time after the water gauge detects the water level of the hot water tank to be smaller than a reference level.

6. The hot water supplying refrigerator according to claim 5, further comprising a regulating valve provided to the hot water pipe and the water supplying pipe adjacent to the hot water tank, to regulate water flowing in and out of the hot water tank.

7. The hot water supplying refrigerator according to claim 2, wherein the circulating part further comprises a pump switch selecting operating (on) or stopping (off) of the pump.

8. The hot water supplying refrigerator according to claim 7, wherein the control part operates the pump for a predetermined time, when the operating of the pump is selected via the pump switch.

9. The hot water supplying refrigerator according to claim 7, wherein the circulating part further comprises:
a second temperature sensor provided to one of the hot water pipe and the circulating pipe, and
the control part operates the pump when the operating of the pump is selected in the pump switch, and a temperature measured by the second temperature sensor is determined to be smaller than a predetermined pump operating temperature.

10. The hot water supplying refrigerator according to claim 11, wherein after the pump is operated, the control part stops operating of the pump when the temperature measured by the second temperature sensor is determined to be larger than a predetermined pump stopping temperature.

11. The hot water supplying refrigerator according to claim 2, wherein the control part operates the heater to interlock with the operating of the pump.

12. The hot water supplying refrigerator according to claim 2, further comprising a hot water valve provided to the hot water pipe between the dispenser and a diverging part of the hot water pipe and the circulating pipe, to regulate water supplied to the dispenser.

13. The hot water supplying refrigerator according to claim 12, wherein the dispenser comprises an input part to select cold water or hot water.

14. The hot water supplying refrigerator according to claim 13, further comprising a valve switch selectively opening and closing the hot water valve,
wherein the control part opens the hot water valve when the hot water is selected in the input part, and the valve switch is operated.

15. The hot water supplying refrigerator according to claim 14, wherein the dispenser further comprises:
an outlet connected to the hot water pipe to eject the hot water, and
a water lever selectively opening and closing the outlet, wherein
the valve switch interlocks with the water lever.

16. The hot water supplying refrigerator according to claim 1, further comprising a vapor ventilating part provided to an upper part of the hot water tank, to adjust the vapor pressure in the hot water tank.

17. The hot water supplying refrigerator according to claim 16, wherein the vapor ventilating part comprises
a vent housing comprising:
a vapor inflow hole receiving vapor in the hot water tank,
a vapor outflow hole ejecting vapor received through the vapor inflow hole to an outside, and
a vapor channel connecting the vapor inflow hole and the vapor outflow hole, and
a vent lid movably provided between the vapor inflow hole and the vapor outflow hole to approach or withdraw from the vapor inflow hole depending on the vapor pressure in the hot water tank to open and close the vapor inflow hole.

18. The hot water supplying refrigerator according to claim 4, further comprising:
a heater switch to select one of a normal mode in which the heater selectively heats and stops heating water stored in the hot water tank and a suspended mode in which the normal mode is withdrawn to suspend operating of the heater,
wherein the control part controls the heater to maintain water stored in the hot water tank at a predetermined temperature when the normal mode is selected in the heater switch.

19. The hot water supplying refrigerator according to claim 18, wherein the control part closes the water supplying valve and stops operating of the heater when the suspended mode is selected in the heater switch.

20. The hot water supplying refrigerator according to claim 2, further comprising:
a hinge part comprising a hollow hinge shaft provided to one of the main body and the door, and
a hinge shaft coupling part provided to the other of the main body and the door to be rotatably coupled with the hollow hinge shaft,
wherein the hot water tank is disposed to an upper part of the main body, and the hot water pipe and the circulating pipe are disposed inside the hollow hinge shaft.

21. A hot water supplying refrigerator comprising a main body comprising a storage compartment, a door opening and closing the storage compartment, and a dispenser provided to the door, comprising:
a hot water tank provided to an upper part of the main body, to store water supplied from an outside;
a heater to heat water stored in the hot water tank;
a hot water pipe to connect the hot water tank and the dispenser;
a circulating part to circulate water remaining in the hot water pipe to the hot water tank; and
a selecting part to select one of a normal mode in which the heater selectively heats and stops heating water stored in the hot water tank and a suspended mode in which the normal mode is withdrawn to suspend operating of the heater.

22. The hot water supplying refrigerator according to claim 21, wherein the circulating part comprises
a circulating pipe diverging from the hot water pipe to be connected with the hot water tank, and
a pump to forcedly circulate water remaining in the hot water pipe and the circulating pipe to the hot water tank.

23. The hot water supplying refrigerator according to claim 22, wherein the circulating part further comprises a pump switch to selectively operate the pump.

24. The hot water supplying refrigerator according to claim 22, further comprising a vapor ventilating part provided to an upper part of the hot water tank, to adjust the vapor pressure in the hot water tank.

25. The hot water supplying refrigerator according to claim 22, further comprising
a water supplying pipe to supply water supplied from an outside to the hot water tank;
a water supplying valve to open and close the water supplying pipe; and
a control part to operate the heater to maintain water stored in the hot water tank at a predetermined temperature when the normal mode is selected in the heater switch, and closing the water supplying valve and stopping operating of the heater when the suspended mode is selected in the heater switch.

26. The hot water supplying refrigerator according to claim 21, further comprising: a hinge part comprising:
a hollow hinge shaft provided to one of the main body and the door, and
a hinge shaft coupling part provided to the other of the main body and the door to be rotatably coupled with the hollow hinge shaft,
wherein the hot water tank is disposed to an upper part of the main body, and the hot water pipe and the circulating pipe are disposed inside the hollow hinge shaft.

27. A hot water supplying refrigerator comprising a main body comprising a storage compartment, a door opening and closing the storage compartment, and a dispenser provided to the door, the refrigerator comprising:
a hot water tank to store water supplied from an outside;
a hot water pipe to connect the hot water tank with the dispenser;
a circulating pipe diverging from the hot water pipe to be connected with the hot water tank;
a hot water valve provided to the hot water pipe between the dispenser and a diverging part of the hot water pipe and the circulating pipe, to regulate water supplied to the dispenser;
a temperature sensor provided between the hot water tank and the hot water valve to measure a temperature of the water; and
a pump to forcedly circulate water remaining in the hot water pipe and the circulating pipe to the hot water tank.

28. The hot water supplying refrigerator according to claim 27, further comprising:
a control part to control operation of the pump in the state that the hot water valve is closed when the temperature measured by the temperature sensor is determined to be smaller than a predetermined pump operating temperature.

29. A hot water supplying refrigerator comprising a main body comprising a storage compartment, a door opening and closing the storage compartment, and a dispenser provided to the door, the refrigerator comprising:
a hot water tank to store water supplied from an outside;
a hot water pipe to connect the hot water tank with the dispenser;
a circulating pipe diverging from the hot water pipe to be connected with the hot water tank;
a pump to forcedly circulate water remaining in the hot water pipe and the circulating pipe to the hot water tank;
a hot water valve provided to the hot water pipe between the dispenser and a diverging part of the hot water pipe and the circulating pipe, to regulate hot water supplied to the dispenser;
a water lever to selectively open and close the hot water valve; and
a control part to control the pump to interlock with the water lever.

30. The hot water supplying refrigerator according to claim 29, wherein the control part opens the hot water valve after operating the pump for a predetermined time in the state that the hot water valve is closed, when the hot water valve is selected to be opened in the water lever.

31. A control method of a hot water supplying refrigerator comprising a main body comprising a storage compartment, a door, a dispenser provided to the door, a hot water tank, a heater, a hot water pipe connecting the hot water tank and the dispenser, a circulating part comprising a circulating pipe diverging from the hot water pipe to be connected with the hot water tank, and a pump, the method comprising:
storing water supplied from an outside in the hot water tank;
heating the water stored in the hot water tank;
connecting the hot water tank to the dispenser;
operating the pump to forcedly circulate water remaining in the hot water pipe connected with the hot water tank and the circulating pipe to the hot water tank.

32. The control method of the hot water supplying refrigerator according to claim 31, wherein the operating the pump is performed for a predetermined time.

33. The control method of the hot water supplying refrigerator according to claim 31, wherein the operating the pump is performed based on a temperature measured by a temperature sensor provided to at least one of the hot water pipe and the circulating pipe.

34. The control method of the hot water supplying refrigerator according to claim 32, wherein the hot water supplying refrigerator further comprises a hot water valve provided to the hot water pipe between the dispenser and a diverging part of the hot water pipe and the circulating pipe to regulate a hot water supplied to the dispenser, and a water lever opening and closing the hot water valve, and
the operating of the pump further comprises opening the hot water valve after operating the pump for a predetermined time in the state that the hot water valve is closed, when the hot water valve is selected to be opened via the water lever.

35. A refrigerator comprising a dispenser, the refrigerator comprising:
a hot water tank to store water supplied from an outside;
a heater to heat water stored in the hot water tank;
a hot water pipe to connect the hot water tank and the dispenser; and
a circulating part to circulate water remaining in the hot water pipe after hot water has been dispensed from the dispenser, back to the hot water tank to thereby maintain the hot water at a constant temperature.
